(19) United States
(12) Patent Application Publication
(10) Pub. No.: US 2025/0371906 A1
(43) Pub. Date: Dec. 4, 2025

(54) QUANTUM WATERMARKING OF BIOMETRIC IDENTIFIERS

(71) Applicant: American Express Travel Related Services Company, Inc., New York, NY (US)

(72) Inventors: John Thomas Hancock, III, Deerfield Beach, FL (US); Hiranmayi Palanki, III, Tampa, FL (US)

(21) Appl. No.: 18/679,253

(22) Filed: May 30, 2024

(51) Int. Cl. G06V 40/40; G06T 1/00; G06V 40/12; G06V 40/16; G10L 17/00

(52) U.S. Cl. CPC G06V 40/40; G06T 1/0021; G06V 40/1382; G06V 40/166; G10L 17/00

(57) ABSTRACT

Disclosed are various approaches for distinguishing between genuine biometric identifiers and fabricated or fraudulent biometric identifiers created using generative artificial intelligence (GenAI). One or more watermarks and one or more encryption keys can be distributed to authorized client applications executing on trusted client devices of users. A watermark can be encrypted and then embedded into a biometric identifier using a quantum computing device. To verify the authenticity of the biometric identifier, a quantum computing device can be used to extract the watermark from the biometric identifier. The watermark can then be decrypted. If the decrypted watermark is successfully extracted and decrypted, then it can be determined that the biometric identifier is legitimate.

### BACKGROUND

Biometric identification is often used as primary or secondary mechanism for authenticating the identity of users. For example, palm prints, fingerprints, iris scans, facial recognition, voice recognition, and similar biometric identification approaches can be used to authenticate a user from an impostor or impersonator. Biometric identification is often used because of the distinctiveness and uniqueness in the biometric characteristics between individuals.

However, the emergence of generative artificial intelligence (“generative AI” or “GenAI”) has enabled the creation of ultra-realistic counterfeits of biometric identifiers of individual users. For example, generative AI can be used to create photos, video, or audio impersonating a user. These photos, video, or audio can be highly realistic to the point that they are indistinguishable from a genuine photo, video, or audio sample. As a result, photos, video, or audio created using generative AI can be used to bypass authentication systems that rely on biometric identification.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a network environment according to various embodiments of the present disclosure.

FIG. 2 is a flowchart illustrating one example of functionality implemented as portions of a client application in the network environment of FIG. 1 for obtaining a quantum watermarked biometric identifier according to various embodiments of the present disclosure.

FIG. 3 is a flowchart illustrating one example of functionality implemented as portions of a quantum watermarking service executed in the network environment of FIG. 1 for the purpose of creating a quantum watermarked biometric identifier according to various embodiments of the present disclosure.

FIG. 4 is a flowchart illustrating one example of functionality implemented as portions of a quantum watermarking service executed in the network environment of FIG. 1 for the purpose of extracting a watermark from a quantum watermarked biometric identifier according to various embodiments of the present disclosure.

FIG. 5 is a sequence diagram illustrating one example of the interactions between the various components of the network environment of FIG. 1 for distributing encryption keys and watermarks in a secure fashion.

FIG. 6 is a sequence diagram illustrating one example of the interactions between the various components of the network environment of FIG. 1 for using quantum watermarked biometric identifiers to access protected services.

### DETAILED DESCRIPTION

Disclosed are various approaches for distinguishing between genuine biometric identifiers and fabricated or fraudulent biometric identifiers created using generative artificial intelligence (generative AI or GenAI). Historically, biometric identification has been used to authenticate and identify individuals because of the difficulty in forging or counterfeiting biometric credentials. For example, a user could have his or her password stolen or guessed, but a user's fingerprints, iris print, voice print, and facial structure are unique to each individual user and cannot be duplicated. Accordingly, face scanning, iris scanning, fingerprint scanning, and voice recognition have been employed as methods for limiting access to authorized users only.

However, the advent of generative AI has allowed for computers to create “deep fakes,” which are fraudulent, counterfeit, or otherwise false representations of individuals. These “deep fakes” can be outstandingly realistic to the point that they can fool biometric identification systems. For example, a generative AI algorithm can be used to alter the voice of one individual to match the voice of another individual. Similarly, generative AI algorithms can create realistic looking, but false, images of individuals with a remarkably high-degree fidelity. As a result, generative AI algorithms can be employed in a video conference to alter the visual appearance and voice of an individual in real-time to match the look and appearance of another individual as well as the sound of their voice. As generative AI algorithms become more powerful and more capable, they will be able to create fraudulent, but realistic, biometric identifiers (e.g., facial images, fingerprint images, iris images, voice recordings, etc.) that can bypass traditional biometric authentication systems.

Accordingly, various embodiments of the present disclosure involve mechanisms for distinguishing authentic biometric identifiers from fraudulent biometric identifiers. In particular, one or more watermarks and one or more encryption keys are distributed to authorized client applications executing on trusted client devices of users. A watermark can be encrypted and then embedded into a biometric identifier using a quantum computing device. To verify the authenticity of the biometric identifier, a quantum computing device can be used to extract the watermark from the biometric identifier. The watermark can then be decrypted. If the decrypted watermark is successfully extracted and decrypted, then it can be determined that the biometric identifier is legitimate. By using individual watermarks and encryption keys only once, generative AI algorithms will have insufficient training data to recreate watermarked biometric identifiers. Therefore, various embodiments of the present disclosure are able to distinguish between authentic and fabricated biometric identifiers in spite of continuing advances related to generative AI.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

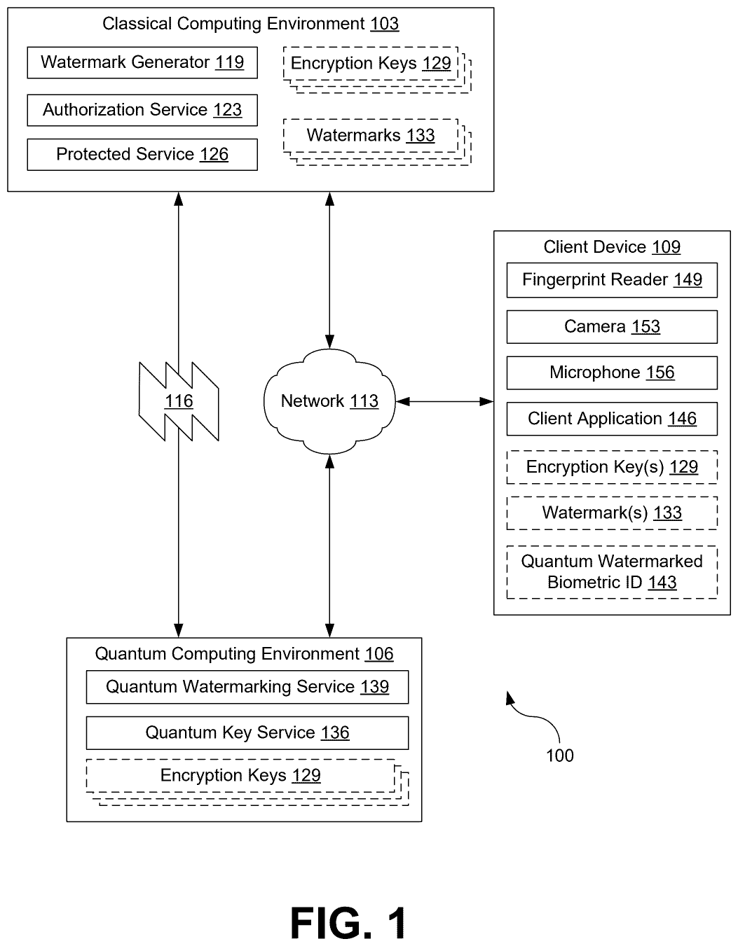

With reference to FIG. 1, shown is a network environment 100 according to various embodiments. The network environment 100 can include a classical computing environment 103, quantum computing environment 106, and a client device 109, which can be in data communication with each other via the network 113. Separately, the quantum computing environment 106 and the classical computing environment 103 could be in data connection via a separate quantum secured connection 116.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The quantum secured connection 116 can represent a data connection between the quantum computing environment 106 and the classical computing environment 103 secured using protocols based on quantum mechanics. Examples of such protocols include the BB84 protocol using photon polarization states to transmit information in a secure manner and E91 protocol that uses entangled pairs of photons to transmit information in a secure manner. Other, similar protocols could also be used in various embodiments of the present disclosure.

The classical computing environment 103 can include one or more classical computing devices that perform computations using digital electronics. Accordingly, a classical computing device can include a processor, a memory, and/or a network interface. For example, the computing devices can be configured to perform computations on behalf of other computing devices or applications. As another example, such computing devices can host and/or provide content to other computing devices in response to requests for content.

Moreover, the classical computing environment 103 can employ a plurality of computing devices that can be arranged in one or more server banks or computer banks or other arrangements. Such computing devices can be located in a single installation or can be distributed among many different geographical locations. For example, the classical computing environment 103 can include a plurality of computing devices that together can include a hosted computing resource, a grid computing resource or any other distributed computing arrangement. In some cases, the classical computing environment 103 can correspond to an elastic computing resource where the allotted capacity of processing, network, storage, or other computing-related resources can vary over time.

Various applications or other functionality can be executed in the classical computing environment 103. The components executed on the classical computing environment 103 can include a watermark generator 119, an authorization service 123, and a protected service 126. Other applications, services, processes, systems, engines, or functionality not discussed in detail herein could also be hosted or executed by the classical computing environment 103.

Also, various data is stored in the classical computing environment 103 by the various applications or other components hosted and executed by the classical computing environment. This can include one or more encryption keys 129 and/or one or more watermarks 133. The encryption keys 129 and/or watermarks 133 can be stored in various data stores that are accessible to the classical computing environment 103. These data stores can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store.

An encryption key 129 can represent a symmetric encryption key or an asymmetric encryption key (sometimes referred to as a key-pair or a public/private key-pair). Examples of encryption algorithms that use a symmetric encryption key include the Advanced Encryption Standard (AES) algorithm, Camellia algorithm, Twofish Algorithm, Blowfish Algorithm, Serpent Algorithm, and Salsa20 Algorithm, among others. Examples of encryption algorithms that use an asymmetric encryption key include the Rivest-Shamir-Adleman (RSA) algorithm, Elliptic Curve Integrated Encryption Scheme (ECIES-also referred to as Elliptic Curve Augmented Encryption Scheme or more simply the Elliptic Curve Encryption Scheme). Moreover, in some implementations, each encryption key 129 can include a key identifier that allows for an encryption key 129 to be uniquely identified with respect to another encryption key 129. For example, an encryption key 129 could be hashed (e.g., using the message digest 5 (md5) algorithm, or a version of the Secure Hash Algorithm (e.g., SHA-1, SHA-2, or SHA-3) to create a unique key identifier that uniquely identifies the encryption key 129 with respect to another encryption key 129.

A watermark 133 can represent any item of data that can be inserted or embedded into another item of data (e.g., a file). For example, a watermark 133 could be inserted or embedded into an image file, a video file, and audio file, a document, etc. in order to verify the source and/or authenticity of the file. Moreover, in some implementations, each watermark 133 can include a watermark identifier that allows for a watermark 133 to be uniquely identified with respect to another watermark 133. For example, a watermark 133 could be hashed (e.g., using the message digest 5 (md5) algorithm, or a version of the Secure Hash Algorithm (e.g., SHA-1, SHA-2, or SHA-3) to create a unique watermark identifier that uniquely identifies the watermark 133 with respect to another watermark 133.

The watermark generator 119 can be executed to generate a watermark 133. The watermark generator 119 can be configured to generate a single watermark that is used repeatedly or a plurality of watermarks that can be used for a limited number of times (e.g., for a single instance of authentication).

The authorization service 123 can be executed to perform various authentication and authorization related tasks. For example, the authorization service 123 could be configured to receive one or more encryption keys 129 from the quantum computing environment 106 via the quantum secured connection 116. The authorization service 123 could also be configured to distribute the encryption keys 129 and/or watermarks 133 to various client devices 109 for accessing (or requesting access to) a protected service 126. The authorization service 123 could also be configured to authenticate a user of a client device 109 to determine if the client device 109 (and therefore the user of the client device 109) should be granted access to a protected service 126.

The protected service 126 can represent any service or application that is access protected. Examples of the protected service 126 can include web-based applications, network servers or services, and similar applications or services.

The quantum computing environment 106 is a computing environment that can include one or more classical computing devices and/or one or more quantum computing devices. A classical computing device could be employed to act as an interface between quantum computing devices within the quantum computing environment 106 and other classical computing devices (e.g., classical computing devices in the classical computing environment 103 or client devices 109). A quantum computing device could be employed to perform quantum computing calculations (e.g., quantum image processing).

A quantum computing device is any computing device that can perform computations using quantum mechanical principles. Examples of quantum computing devices include quantum gate array computers, measurement-based quantum computers, quantum annealing computer, adiabatic quantum computers, neuromorphic quantum computers, and topological quantum computers. Different quantum computing devices could be employed to implement particular quantum computing algorithms. Moreover, a quantum computing environment 106 could employ one or more different types of quantum computing devices.

The quantum computing environment 106 can also be configured to execute various applications or services. For example, the quantum computing environment 106 could host a quantum key service 136, a quantum watermarking service 139, and/or potentially other applications or services. Moreover, various data, such as encryption keys 129 can be stored by the quantum computing environment 106.

The quantum key service 136 can be executed to generated and distributed encryption keys 129. For example, the quantum key service 136 could cause one or more classical computing devices or quantum computing devices to generate encryption keys 129. As another example, the quantum key service 136 could cause one or more classical computing devices or quantum computing devices to transmit generated encryption keys 129 to the authorization service 123 of the classical computing environment 103 using the quantum secured connection 116 to prevent eavesdropping and/or interception of the encryption keys 129. As previously discussed, the quantum secured connection 116 can be secured using various quantum key distribution (QKD) protocols, algorithms, or techniques.

The quantum watermarking service 139 can be used to insert a watermark 133 into a file (e.g., an image, video, audio, or other file) using various quantum image processing techniques or similar approaches. For example, the quantum watermarking service 139 could insert a watermark 133 or an encrypted watermark 133 (e.g., encrypted using an encryption key 129) into a biometric identifier (e.g., a file representing biometric information about an individual) using quantum image processing or similar techniques to generate a quantum watermarked biometric identifier 143. The quantum watermarking service 139 could then return the quantum watermarked biometric identifier 143 to the requesting device or application. The quantum watermarking service 139 can also be executed to extract or remove a watermark 133 or encrypted watermark 133 from a quantum watermarked biometric identifier 143.

The client device 109 is representative of a plurality of client devices that can be coupled to the network 113. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 109 or can be connected to the client device 109 through a wired or wireless connection.

The client device 109 can be configured to execute various applications such as a client application 146 or other applications. The client application 146 can be executed in a client device 109 to access the protected service 126 or other servers or services, thereby potentially rendering a user interface on the display. To this end, the client application 146 can include a browser, a dedicated application, or other executable, and the user interface can include a network page, an application screen, or other user mechanism for obtaining user input. The client device 109 can be configured to execute applications beyond the client application 146 such as email applications, social networking applications, word processors, spreadsheets, or other applications.

The client device 109 can also include various sensors or other image or data capture devices for acquiring biometric information about a user of the client device 109. Examples of these devices include fingerprint readers 149, cameras 153, microphones 156, and potentially other devices. The information collected by these devices could be used by the client application 146 to create or verify a biometric identifier of a user of the client device 109.

Moreover, various types of information can be stored on a client device 109 for use by the client application 146. This information can include one or more encryption keys 129, one or more watermarks 133, and/or one or more quantum watermarked biometric identifiers 143.

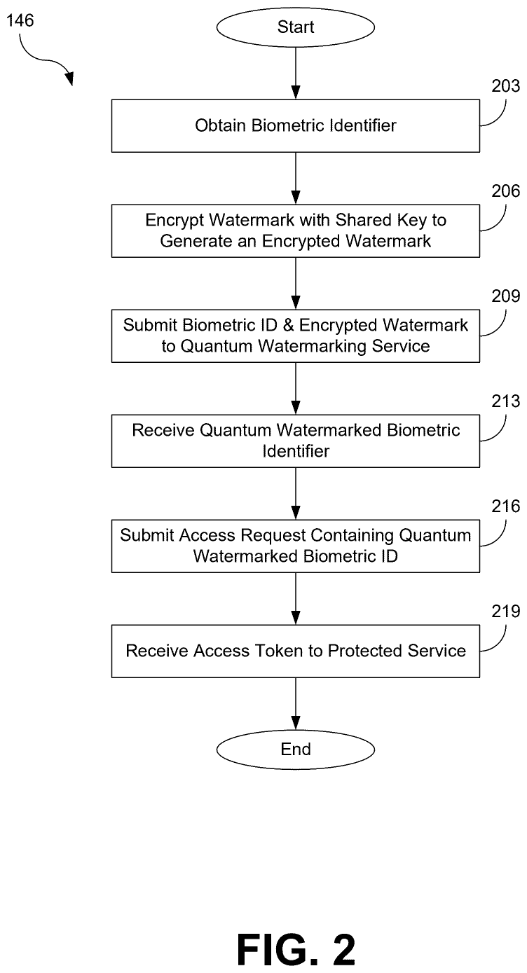

Referring next to FIG. 2, shown is a flowchart that provides one example of the operation of a portion of the client application 146. The flowchart of FIG. 2 provides merely an example of the many different types of functional arrangements that can be employed to implement the operation of the depicted portion of the client application 146. As an alternative, the flowchart of FIG. 2 can be viewed as depicting an example of elements of a method implemented within the network environment 100.

Beginning with block 203, the client application 146 can obtain a biometric identifier of a user of the client device 109. For example, the client application 146 could cause a camera 153 of the client device 109 to capture an image of the face of the user. As another example, the client application 146 could cause a fingerprint reader 149 to capture an image of a fingerprint of the user. In some instances, the client application 146 could cause the microphone 156 to capture a recording of the voice of the user.

Next, at block 206, the client application 146 can generate an encrypted watermark for use with various embodiments of the present disclosure. For example, the client application 146 could encrypt a previously shared watermark 133 with a previously shared encryption key 129. The resulting encrypted watermark could be subsequently used. In some instances, the encryption key 129 could be a one-time or single-use encryption key. In these instances, the encryption key 129 could be discarded after the watermark 133 is encrypted to generate the encrypted watermark. Similarly, the watermark 133 could be a one-time or single-use watermark 133, in which case the watermark 133 could be discarded after the watermark 133 is encrypted to generate the encrypted watermark.

Moving on to block 209, the client application 146 can submit the biometric identifier obtained at block 203 and the encrypted watermark generated at block 206 to the quantum watermarking service 139. This can be done to obtain a quantum watermarked biometric identifier 143.

Then, at block 213, the client application 146 can receive the quantum watermarked biometric identifier 143 from the quantum watermarking service 139. The client application 146 can save the quantum watermarked biometric identifier 143 for subsequent authentication for accessing a protected service 126.

Proceeding to block 216, the client application 146 can submit the quantum watermarked biometric identifier 143 to a protected service 126 to access the protected service 126. Moreover, in some implementations, the request can include the watermark identifier for the watermark 133 embedded in the quantum watermarked biometric identifier 143 and the key identifier for the encryption key 129 used to encrypt the watermark 133.

For example, the client application 146 could submit the quantum watermarked biometric identifier 143 to the protected service 126. The protected service 126 could communicate with the authorization service 123 and/or the quantum watermarking service 139 (as discussed later) to determine if the quantum watermarked biometric identifier 143 is authentic. If the quantum watermarked biometric identifier 143 is authentic, then the protected service 126 could provide an access token to the client application 146 allowing it to access the protected service 126 while the access token is valid (e.g., for a predefined period of time, for the duration of an active session, etc.). As another example, the client application 146 could submit the quantum watermarked biometric identifier 143 to an authorization service 123 to determine if the quantum watermarked biometric identifier 143 is authentic. If the quantum watermarked biometric identifier 143 is authentic, then the authorization service 123 could provide an access token to the client application 146 allowing it to access a protected service 126 while the access token is valid (e.g., for a predefined period of time, for the duration of an active session, etc.).

Subsequently, at block 219, the client application 146 can receive and store the access token. The access token can be used to allow the client application 146 to access the protected service 126 while the access token remains a valid access token. After the access token is received, indicating that the client application 146 has been granted access to the protected service 126, the watermark 133 and encryption key 129 used to create the quantum watermarked biometric identifier 143 can be discarded by the client application 146 if the watermark 133 and encryption key 129 are single-use.

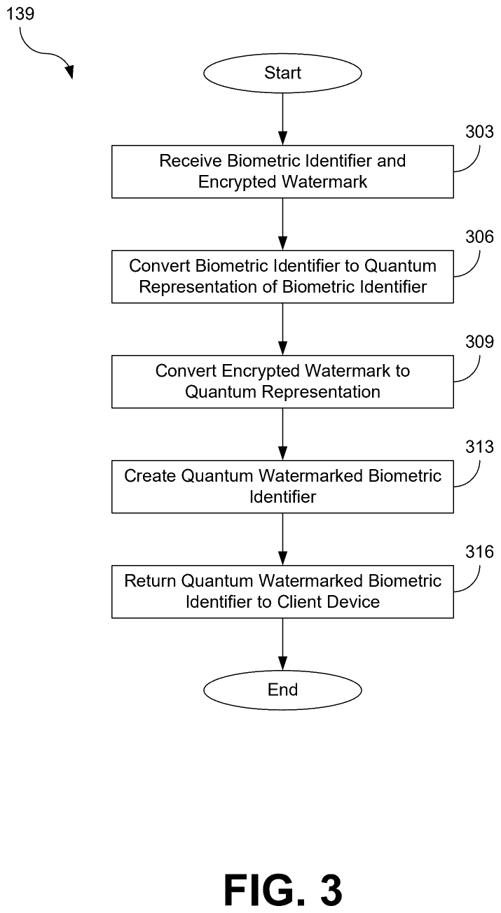

Referring next to FIG. 3, shown is a flowchart that provides one example of the operation of a portion of the quantum watermarking service 139. The flowchart of FIG. 3 provides merely an example of the many different types of functional arrangements that can be employed to implement the operation of the depicted portion of the quantum watermarking service 139. As an alternative, the flowchart of FIG. 3 can be viewed as depicting an example of elements of a method implemented within the network environment 100.

Beginning with block 303, the quantum watermarking service 139 can receive a biometric identifier and an encrypted version of the watermark 133 from a client application 146 executing on the client device 109. This could occur, for example, as part of a request by the client application 146 for a quantum watermarked biometric identifier 143 that is based at least in part on the biometric identifier and the encrypted version of the watermark 133.

Proceeding to block 306, the quantum watermarking service 139 can convert the biometric identifier to a quantum representation of the biometric identifier. This action can be performed to allow the biometric identifier to be processed using a quantum computing device. For example, the quantum watermarking service 139 could use the Flexible Representation of Quantum Images (FRQI) or (NEQR) to convert a digital image of a face, fingerprint, etc. into a quantum representation of digital image. As another example, the quantum watermarking service 139 could use algorithms such as the Flexible Representation of Quantum Audio (FRQA) to convert audio files (e.g., representing a recording of a user's voice) into a quantum representation of the audio file.

Moving on to block 309, the quantum watermarking service 139 can similarly convert the encrypted version of the watermark 133 to a quantum representation. This action can be performed to allow the encrypted version of the watermark 133 to be processed using a quantum computing device. The conversion could be performed using any one of a variety of techniques, including basis encoding, superdense encoding, amplitude encoding, angle encoding, or quantum Fourier Transform encoding. Using basis encoding as an example, a quantum computer could initialize all qubits to the |0> state. It is then possible to programmatically specify that the Not gate be applied to those qubits which should be put into the |1> state such that for every classical bit that has the value 0, the corresponding qubit has the value |0> and for every classical bit that has the value 1, the corresponding qubit has the value |1>.

Then, at block 313, the quantum watermarking service 139 can create a quantum watermarked biometric identifier 143. This can be done by inserting or embedding, using a quantum computing device, the encrypted version of the watermark 133 received at block 303 into the quantum representation of the biometric identifier created at block 306. This can be done using any quantum watermarking algorithm or technique. Some of these quantum watermarking algorithms could, for example, be based on the Haar wavelet transform. Other quantum watermarking algorithms could, for example, use quantum error correction (QEC) to encode the watermark and a geometric transformation of image assembling mechanism to embed the watermark. After the watermarking process is complete, the quantum representation of the biometric identifier with the encrypted watermark 133 included can be converted back to a digital representation, with the quantum watermarked biometric identifier 143 being the result.

Next, at block 316, the quantum watermarking service 139 can return the quantum watermarked biometric identifier 143 to the client application 146 executing on the client device 109.

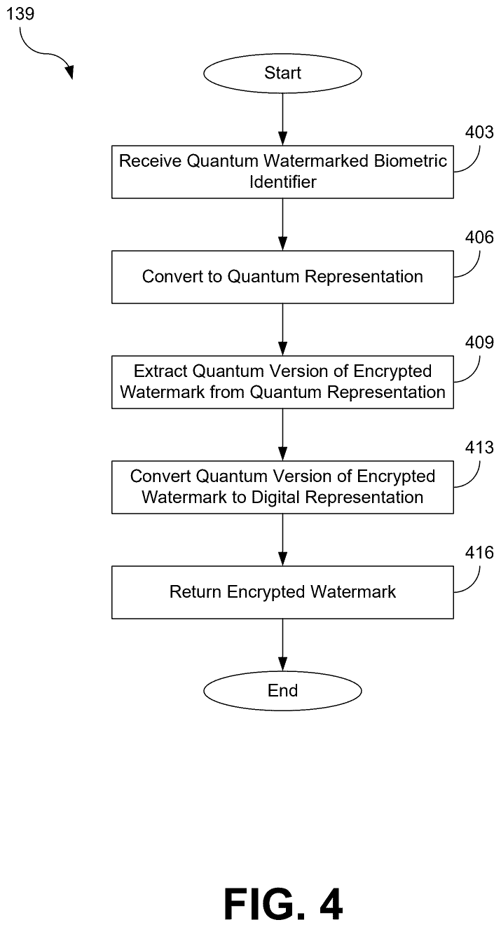

Referring next to FIG. 4, shown is a flowchart that provides one example of the operation of a portion of the quantum watermarking service 139. The flowchart of FIG. 4 provides merely an example of the many different types of functional arrangements that can be employed to implement the operation of the depicted portion of the quantum watermarking service 139. As an alternative, the flowchart of FIG. 4 can be viewed as depicting an example of elements of a method implemented within the network environment 100.

Beginning with block 403, the quantum watermarking service 139 can receive a quantum watermarked biometric identifier 143. The quantum watermarking service 139 could receive the quantum watermarked biometric identifier 143 as part of an authentication process to determine the validity or authenticity of a biometric identifier. In some implementations, the quantum watermarking service 139 can also receive additional information or parameters about the watermark 133 embedded in the quantum watermarked biometric identifier 143, such as the size or type of watermark 133. If no additional information or parameters are provided default parameters (e.g., a default size or type) may be presumed and used for the purposes of detecting a watermark 133 and extracting it.

Then, at block 406, the quantum watermarking service 139 can convert the quantum watermarked biometric identifier 143 to a quantum representation. This can be done to allow the quantum watermarked biometric identifier 143 to be processed using a quantum computing device.

Next, at block 409, the quantum watermarking service 139 can extract a quantum representation of the encrypted watermark 133 from the quantum representation of the quantum watermarked biometric identifier 143. For example, the quantum watermarking service 139 could analyze the quantum watermarked biometric identifier 143 to determine if it has been watermarked based on the known or expected parameters of a watermark 133. If the quantum watermarked biometric identifier 143 has been watermarked, then the encrypted version of the watermark 133 could be extracted from the quantum watermarked biometric identifier 143. This can be done using the reverse or inverse of the quantum watermarking technique used to insert or embed the encrypted watermark 133 into the quantum watermarked biometric identifier 143.

Moving on to block 413, the quantum watermarking service 139 can convert the encrypted version of the watermark 133 extracted from the quantum watermarked biometric identifier 143 at block 409 into a digital or binary form appropriate for processing by a computing device (e.g., a computing device in the classical computing environment 103 or a client device 109). This can be accomplished by converting individual qubits into classical bits using a measuring device.

Using basis encoding as an example, when a qubit in the state |0> is measured, there is a probability of 1.0 that the measurement device will show that the two complex numbers that characterize the qubit will have the values 1 and 0, respectively. Hence, when a qubit in the state |1> is measured, there is a probability of 1.0 that the measurement device will show that the two complex numbers that characterize the qubit will have the values 0 and 1 respectively. Quantum computing platforms provide an abstract measurement function for developers to utilize.

Subsequently, at block 416, the quantum watermarking service 139 can return the encrypted form of the watermark 133 to the requesting device or service.

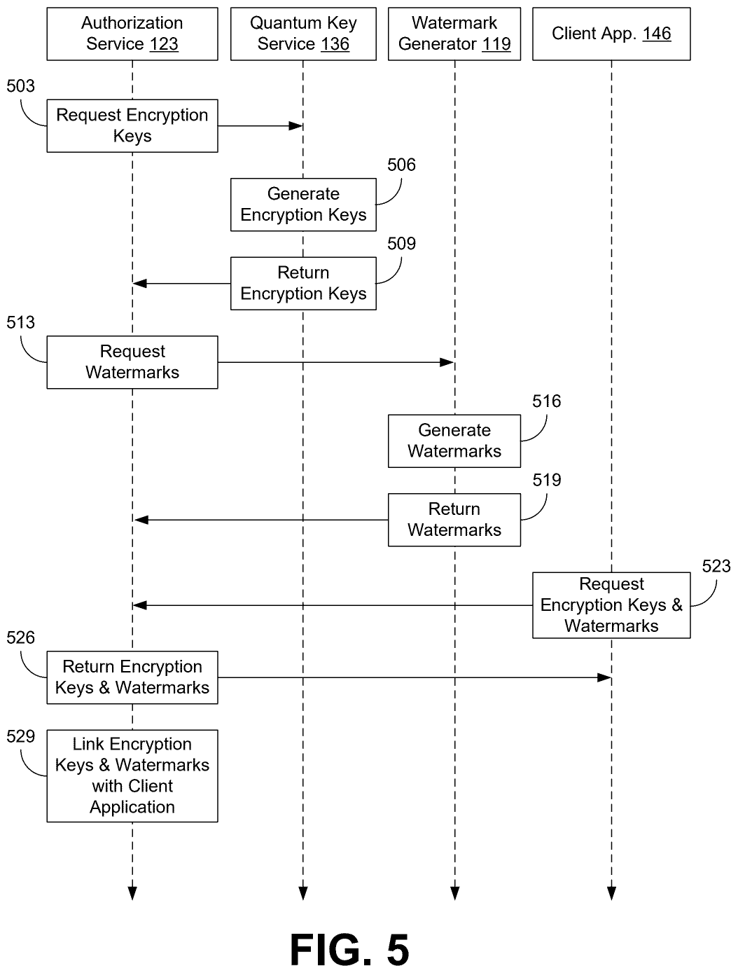

Referring next to FIG. 5, shown is a sequence diagram that provides one example of the interactions between the watermark generator 119, authorization service 123, quantum key service 136, and client application 146. The sequence diagram of FIG. 5 provides merely an example of the many different types of interactions between the depicted portions of the watermark generator 119, authorization service 123, quantum key service 136, and client application 146. As an alternative, the sequence diagram of FIG. 5 can be viewed as depicting an example of elements of a method implemented within the network environment 100.

Beginning with block 503, the authorization service 123 can request encryption keys 129 from the quantum key service 136. The authorization service 123 could request multiple encryption keys 129 in bulk in order to have a sufficient amount of encryption keys 129 to issue in those implementations where encryption keys 129 are single-use (e.g., for one-time pad cryptosystems). The authorization service 123 can also include in the request various parameters, such as the type (e.g., symmetric or asymmetric) of key, the algorithm the key will be used for (e.g., AES, RSA, ECC, etc.), and/or length of the key (e.g., 128-bit, 192-bit, 256-bit, 1,024-bit, 2,048-bit, 4,096-bit, etc.).

In response, at block 506, the quantum key service 136 can generate the requested number of encryption keys 129 that satisfy the parameters supplied in the request made at block 503. The quantum key service 136 can generate the keys using various key generation techniques appropriate for the specified algorithms, which can include screening for and removing cryptographically weak keys in certain instances.

Subsequently, at block 509, the quantum key service 136 can return the encryption keys 129 generated at block 506. To prevent interception or compromise of the encryption keys 129 generated at block 506, the encryption keys 129 can be returned to the authorization service 123 using a quantum secured connection 116 and/or a quantum key distribution (QKD) protocol.

At block 513, the authorization service 123 can also request one or more watermarks 133 from the watermark generator 119. The authorization service 123 could request multiple watermarks 133 in bulk in order to have a sufficient amount of watermarks 133 to issue in those implementations where watermarks 133 are single-use (e.g., for one-time pad cryptosystems). In some implementations, the authorization service 123 could specify parameters for the watermarks 133 (e.g., size of the watermark) depending on how the watermarks 133 will be used. For instance, a smaller watermark 133 may be needed for use in an image of a fingerprint compared to an image of a face.

In response to the request made at block 513, the watermark generator 119 can, at block 516, generate the requested number of watermarks 133 that satisfy any included parameters. Then, at block 519, the watermark generator 119 can return the watermarks 133 generated at block 516.

Later, at block 523, the client application 146 can send a request for one or more encryption keys 129 and one or more watermarks 133 to the authorization service 123. This could be performed, for example, whenever the client application 146 requires additional encryption keys 129 or watermarks for authenticating with the authorization service 123. In some implementations, the client application 146 can include a unique identifier that uniquely identifies the client application 146 or client device 109 with respect to other client applications 146 or other client devices 109.

In response, at block 526, the authorization service 123 can select a number of encryption keys 129 and watermarks 133 that satisfy the request provided by the client application 146. The authorization service 123 can then return the selected encryption keys 129 and watermarks 133 to the client application 146. To prevent interception and compromise of the encryption keys 129 or watermarks 133, the authorization service 123 can return the encryption keys 129 and watermarks 133 using an encrypted connection across the network 113. The client application 146 can store the encryption keys 129 and watermarks 133 on the client device 109 upon receipt.

At block 529, the authorization service 123 can also link or otherwise record the association between the encryption keys 129 and watermarks 133 selected at block 526 and returned to the client application 146 and the client application 146 itself. For example, the authorization service 123 can record the unique identifier provided at block 523 in association with the key identifier of each encryption key 129 or the watermark identifier of each watermark 133. This can be done to prevent reuse of subsequently compromised encryption keys 129 or watermarks 133 by third parties. As another example, the authorization service 123 can record the unique identifier provided at block 523 in association with the watermark identifier of each watermark 133.

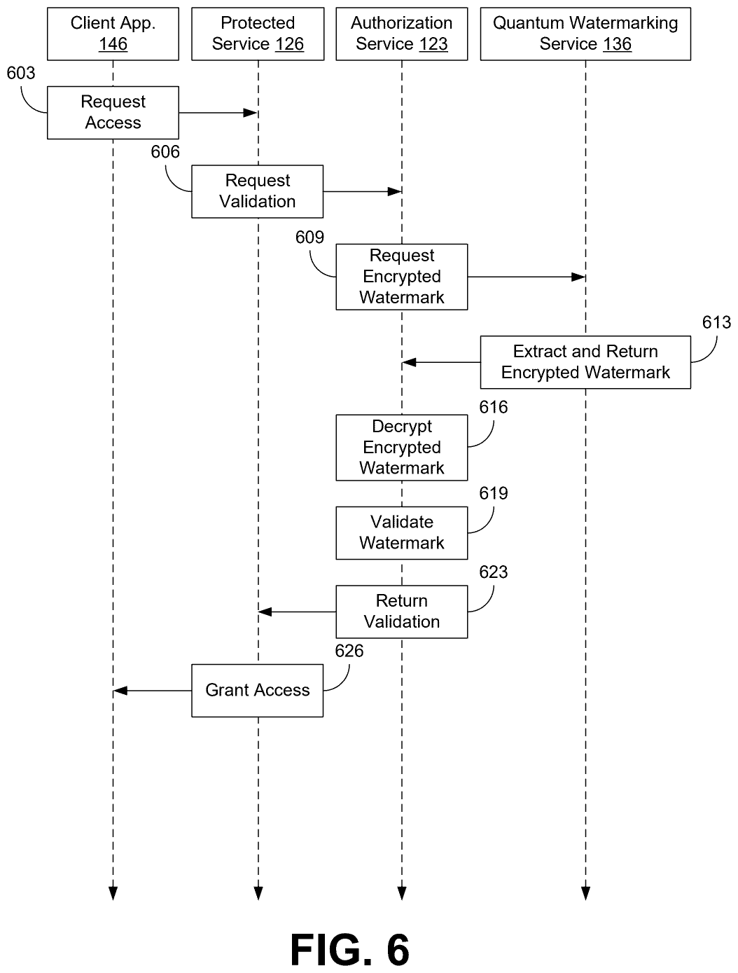

Referring next to FIG. 6, shown is a sequence diagram that provides one example of the interactions between the authorization service 123, the protected service 126, the quantum watermarking service 139, and the client application 146. The sequence diagram of FIG. 6 provides merely an example of the many different types of interactions between the depicted portions of the authorization service 123, the protected service 126, the quantum watermarking service 139, and the client application 146. As an alternative, the sequence diagram of FIG. 6 can be viewed as depicting an example of elements of a method implemented within the network environment 100.

For example, beginning with block 603, the client application 146 can send a request to a protected service 126 to access the protected service 126. As part of the access request and authentication process, the protected service 126 could request or require that the client application 146 provide information identifying the user of the client device 106 (e.g., a username or similar identifier) and information authenticating or verifying the identity of the user, such as a quantum watermarked biometric identifier 143. The access request could also include the watermark identifier for the watermark 133 embedded within the quantum watermarked biometric identifier 143 and the key identifier for the encryption key 129 used to encrypt the watermark 133, as well as the unique identifier for the client application 146 or client device 109 that is associated the key identifier and/or the watermark identifier. The quantum watermarked biometric identifier 143 could have been generated using the process previously described in FIGS. 2 and 3. Additional information that authenticates or verifies the identity of the user (e.g., a personal identification number (PIN) or password known only to the user, a one-time password or passcode generated using an authenticator application or hardware token, etc.).

At block 606, the protected service 126 can request validation of the quantum watermarked biometric identifier 143. Accordingly, the protected service 126 can forward to the authorization service 123 the quantum watermarked biometric identifier 143, the key identifier for the encryption key 129 used to encrypt the watermark 133, and the watermark identifier that uniquely identifies the watermark 133, as well as the unique identifier for the client application 146 or client device 109 that is associated with the key identifier and/or the watermark identifier.

At block 609, the authorization service 123 can forward the quantum watermarked biometric identifier 143 to the quantum watermarking service 136. This can be done in order for the authorization service 123 to obtain the encrypted version of the watermark 133 embedded in the quantum watermarked biometric identifier 143. The request can include additional information, such as the type of watermark, size of the watermark, etc. The authorization service 123 could obtain this additional information by querying, referencing, or otherwise analyzing the watermark 133 identified by the watermark identifier.

At block 613, the quantum watermarking service 136 can extract the encrypted version of the watermark 133 using the process previously described in FIG. 4. One extracted, the quantum watermarking service 136 can return the encrypted version of the watermark 133 to the authorization service 123.

Then, at block 616, the authorization service 123 can decrypt the encrypted version of the watermark 133 returned by the quantum watermarking service 136. For example, the authorization service 123 could select the encryption key 129 corresponding to the key identifier supplied or provided by the client application 146 to decrypt the encrypted version of the watermark 133. However, if such an encryption key 129 does not exist, this could indicate that an encryption key 129 is being reused (e.g., by a malicious third-party) and the decryption and validation process would fail. If such an encryption key 129 exists, then the authorization service 123 could decrypt the encrypted version of the watermark 133 to obtain the watermark 133. Subsequent to decryption, the authorization service 123 could discard the encryption key 129 so that it could no longer be used in order to prevent replay attacks performed by malicious third-parties who may have intercepted or otherwise compromised the encryption key 129.

Next, at block 619, the authorization service 123 can validate the watermark 133 that was decrypted. For example, the authorization service 123 could determine if the watermark 133 that was decrypted matches a watermark 133 stored by the authorization service 123. This could be accomplished by searching for a watermark 133 with a matching watermark identifier and comparing the two watermarks 133 to determine if they match. If the watermarks 133 match, then the watermark 133 provided by the client application 146 is valid. However, if the watermarks 133 do not match, or if a matching watermark 133 cannot be found, then the watermark supplied by the client application 146 is invalid (e.g., because it has already been used to watermark a previous quantum watermarked biometric identifier 143). After the validation process is performed, the watermark 133 stored by the authorization service 123 can be discarded to prevent reuse that could result in unauthorized access to the protected service 126.

Proceeding to block 623, the authorization service 123 can return the result of the validation process to the protected service 126. This can be either an indication that the quantum watermarked biometric identifier 143 is valid, or that the quantum watermarked biometric identifier 143 is invalid. A valid quantum watermarked biometric identifier 143 is a quantum watermarked biometric identifier 143 that includes a valid watermark 133 in encrypted form that could be decrypted using a valid encryption key 129. An invalid quantum watermarked biometric identifier 143 would fail either of these criteria.

Assuming that the quantum watermarked biometric identifier 143 is valid, then at block 626 the protected service 126 can grant access to the client application 146. For example, assuming that the biometric data (e.g., face scan or image, fingerprint image, voice print, etc.) contained in the quantum watermarked biometric identifier 143 matches a known, authentic biometric identifier for the user of the client application 146 (e.g., a previously verified face scan or image, fingerprint image, or voice print), then the protected service 126 could authorize the user of the client application 146 and grant it access. Accordingly, the protected service 126 could generate and provide an access token to the client application 146 that, when included in a request to access the protected service, grants the client application 146 access to the protected service 126 (e.g., for a predefined period of time, for the duration of a session, etc.).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client device comprising a processor and a memory; and
machine-readable instructions stored in the memory that, when executed by the processor, cause the client device to at least:
obtain a biometric identifier of a user of the client device;
encrypt a previously shared watermark with a shared key to generate an encrypted watermark;
submit the biometric identifier and the encrypted watermark to a quantum watermarking service;
receive a quantum watermarked biometric identifier from the quantum watermarking service; and
submit the quantum watermarked biometric identifier to a protected service for access to the protected service.

2. The system of claim 1, wherein the biometric identifier is an image of a fingerprint and the machine-readable instructions that cause the client device to obtain the biometric identifier further cause the computing device to obtain the image of the fingerprint using a fingerprint reader of the client device.

3. The system of claim 1, wherein the biometric identifier is an image of a face of the user and the machine-readable instructions that cause the client device to obtain the biometric identifier further cause the computing device to obtain the image of the face using a camera of the client device.

4. The system of claim 1, wherein the biometric identifier is an audio recording of a voice of the user and the machine-readable instructions that cause the client device to obtain the biometric identifier further cause the computing device to obtain the audio recording of the voice using a microphone of the client device.

5. The system of claim 1, wherein the machine-readable instructions further cause the computing device to at least obtain the shared key and the previously shared watermark from the authorization service.

6. The system of claim 1, wherein the machine-readable instructions further cause the computing device to at least discard the shared key subsequent to receipt of the quantum watermarked biometric identifier.

7. The system of claim 1, wherein the machine-readable instructions further cause the computing device to at least discard the shared watermark subsequent to receipt of the quantum watermarked biometric identifier.

8. A method, comprising:
receiving, from a client device, a biometric identifier and an encrypted version of a watermark;
converting the biometric identifier to a quantum representation of the biometric identifier;
converting the encrypted version of the watermark to a quantum representation of the encrypted version of the watermark;
watermarking, with a quantum computing device, the quantum representation of the biometric identifier with the quantum representation of the encrypted version of the watermark to create a quantum watermarked biometric identifier;
converting the quantum watermarked biometric identifier to a digital representation of the quantum watermarked biometric identifier; and
returning, to the client device, the digital representation of the quantum watermarked biometric identifier.

9. The method of claim 8, wherein:
the biometric identifier is a digital image of a face of a user of the client device; and
converting the biometric identifier to a quantum representation of the biometric identifier further comprises encoding the biometric identifier using a flexible representation of quantum images (FRQI) or a novel enhanced quantum representation (NEQR) approach to generate the quantum representation of the biometric identifier.

10. The method of claim 8, wherein:
the biometric identifier is a digital image of a fingerprint of a user of the client device; and
converting the biometric identifier to a quantum representation of the biometric identifier further comprises encoding the biometric identifier using a flexible representation of quantum images (FRQI) or a novel enhanced quantum representation (NEQR) approach to generate the quantum representation of the biometric identifier.

11. The method of claim 8, wherein:
the biometric identifier is an audio recording of a voice of a user of the client device;
converting the biometric identifier to a quantum representation of the biometric identifier further comprises encoding the biometric identifier using a flexible representation of quantum audio (FRQA) approach to generate the quantum representation of the biometric identifier.

12. The method of claim 8, wherein the quantum computing device is a quantum gate array computer.

13. The method of claim 8, wherein the quantum computing device is an adiabatic quantum computer.

14. The method of claim 8, wherein the quantum computing device is a quantum annealing computer.

15. A method, comprising:
receiving a request to validate a quantum watermarked biometric identifier containing an encrypted version of a watermark, wherein the request includes a key identifier for an encryption key and a watermark identifier for the watermark;
providing the quantum watermarked biometric identifier to a quantum watermarking service;
receiving, from the quantum watermarking service, an encrypted version of the watermark;
selecting an encryption key based at least in part on the key identifier;
decrypting the encrypted version of the watermark with the encryption key to obtain the watermark;
identifying a stored copy of the watermark based at least in part on the watermark identifier; and
comparing the watermark to a stored copy of the watermark to determine that the watermark is valid, wherein the quantum watermarked biometric identifier is valid if the watermark matches the stored copy of the watermark.

16. The method of claim 15, further comprising replying to the request to validate the quantum watermarked biometric identifier that the quantum watermarked biometric identifier is valid.

17. The method of claim 15, further comprising discarding the stored copy of the watermark subsequent to comparing the watermark to the stored copy of the watermark.

18. The method of claim 15, further comprising discarding the encryption key subsequent to decrypting the encrypted version of the watermark.

19. The method of claim 15, wherein the encryption key is received from a quantum key service using a quantum secured connection.

20. The method of claim 15, wherein the request to validate the quantum watermarked biometric identifier is received from a protected service.
